(19) United States
(12) Patent Application Publication
(10) Pub. No.: US 2016/0050066 A1
(43) Pub. Date: Feb. 18, 2016

(54) MANAGEMENT OF AN ENCRYPTION KEY FOR A SECURE DATA STORAGE DEVICE ON A TRUSTED DEVICE PAIRED TO THE SECURE DEVICE OVER A PERSONAL AREA NETWORK

(71) Applicant: Louis Nunzio Loizides, New Berlin, WI (US)

(72) Inventor: Louis Nunzio Loizides, New Berlin, WI (US)

(21) Appl. No.: 14/704,927

(22) Filed: May 5, 2015

Related U.S. Application Data
(60) Provisional application No. 62/037,100, filed on Aug. 13, 2014.

(51) Int. Cl. H04L 9/08

(52) U.S. Cl. CPC H04L 9/0819; H04L 9/0897; H04L 9/0827

(57) ABSTRACT

In one aspect, a system comprises a trusted device comprising a memory storing an encryption key and a processor. The system also comprises a secured data storage device comprising a memory, wherein a portion of the memory is allocated for sensitive data; and a processor, configured to pair, through a network, with the trusted device. The memory of the trusted device comprises instructions that when executed by the processor of the trusted device cause the trusted device to transfer, through the first network, the encryption key to the secured data storage device. Upon receiving the encryption key, the secured data storage device enables access to the allocated portion of the memory of the secured data storage device.

### CLAIM OF PRIORITY

This application claims priority to U.S. Provisional Patent Application Ser. No. 62/037,100, filed Aug. 13, 2014, the entire disclosure of which is hereby expressly incorporated by reference herein.

### FIELD OF TECHNOLOGY

This disclosure relates generally to data processing devices and, more particularly, to a system to secure a networked device.

### BACKGROUND

A recent study indicated that the cost of data breaches was almost $200 per capita in 2011. 95% of losses are unintentional and approximately half are due to the loss of a storage medium such as a USB device.

To prevent data breached many companies require the use of encrypted storage devices, most commonly encrypted USB thumb drives. But data breaches involving USB devices are still common. This, combined with the fact that encrypted devices are difficult to break, implies that employees of those organizations must not be using encrypted devices.

Existing encrypted devices have the following drawbacks:

Many use complex encryption software stored on the device. This software can only run on specific host computers, making the encrypted drives useless on many platforms. Running software stored on the device is also very slow.

In some cases, software such as TrueCrypt™ or BitLocker™ can be used to secure a device. But the software works on a limited number of PCs. Software encryption requires a lot of processing power. This will slow down data transfer and drain battery life.

In cases 1 and 2 the encryption keys are stored on the device which is insecure as if the device is stolen the encryption key can be reverse engineered.

Some devices use a keypad or finger print reader to gain access. These methods of securing, while fast, are much weaker to implement than normal passwords. Keypads have limited combinations that can be easily broken. Fingerprint readers can be defeated by lifting fingerprints off of the devices.

These drawbacks are dissuading users from adopting encrypted storage devices. The invention claimed here solves each of these issues by managing a device's encryption key on a network connected device.

Most companies want to control mobile devices containing company data, even if the devices are personal devices. Primarily these companies want a remote wipe switch to wipe out a device in case of a data breach. Mobile device management (MDM) platforms such as Airwatch™ or Mobilelron™ exist to provide remote wiping capability for mobile phones and tablets.

Mobile storage devices such as USB thumb drives would benefit from this type of management, but because they're not connected to an external network this is not possible. Adding network connectivity to mobile storage devices, however, is expensive and impractical.

The current invention solves this problem by managing the encryption key used to decrypt a mobile storage device on another, more capable trusted device such as a mobile phone. This mobile phone can be paired to the storage device. In order to decrypt data, therefore, the storage device will have to request the key from the more capable trusted device.

The more capable device will likely be able to be managed remotely by an MDM solution. If the MDM controlled device is wiped, therefore, the key will cease to exist and the data on the storage device is protected. The invention described here, therefore, effectively extends the scope of existing MDM solutions to mobile storage devices.

### SUMMARY

Disclosed is system for securing a networked device.

In one aspect, a system comprises a trusted device comprising a memory storing an encryption key and a processor. The system also comprises a secured data storage device comprising a memory, wherein a portion of the memory is allocated for sensitive data; and a processor, configured to pair, through a network, with the trusted device. The memory of the trusted device comprises instructions that when executed by the processor of the trusted device cause the trusted device to transfer, through the first network, the encryption key to the secured data storage device. Upon receiving the encryption key, the secured data storage device enables access to the allocated portion of the memory of the secured data storage device.

The methods, devices, and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a diagram illustrating an exchange of keys between a trusted device and a secured data storage device as allowed by an external server, according to one or more embodiments.

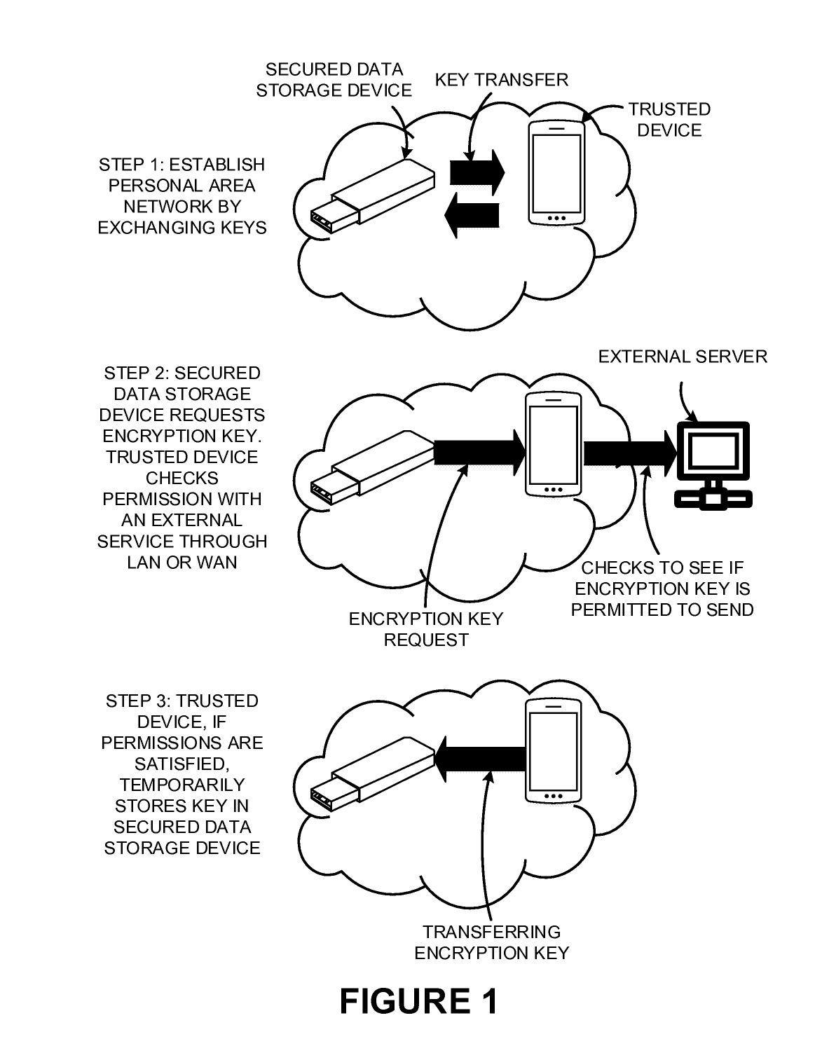

FIG. 2 is a decision flowchart illustrating the exchange of keys between the trusted device and the secured data storage device of FIG. 1 as permitted within locational parameters, according to one or more embodiments.

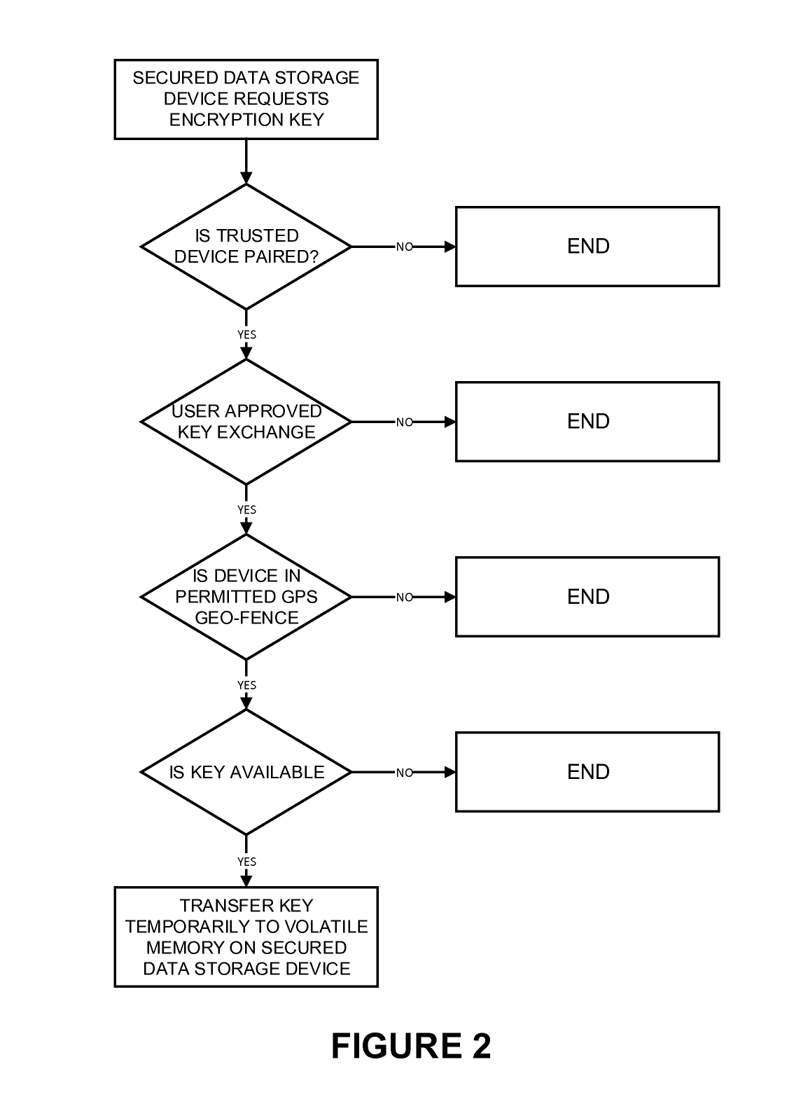

FIG. 3 is an example of a graphical user interface of the trusted device of FIG. 1 used to control key permissions, according to one or more embodiments.

FIG. 4 is a process flowchart of a method of exchanging keys between the trusted device and the secured data storage device of FIG. 1, according to one or more embodiments.

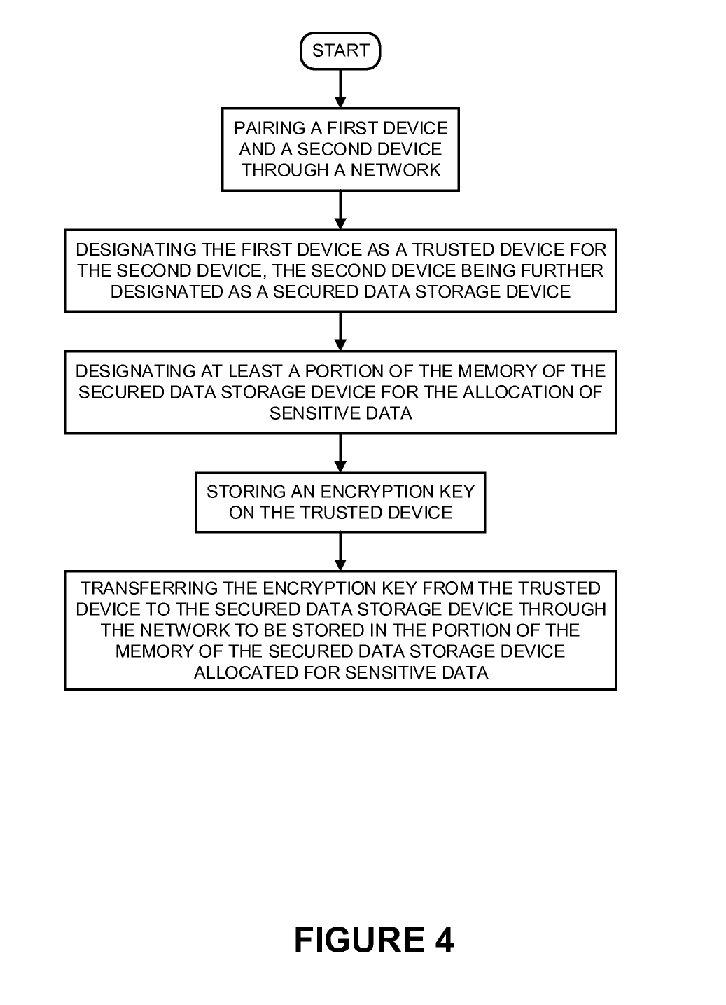

Other features of the present embodiments will be apparent from the accompanying drawings and from the detailed description that follows.

### DETAILED DESCRIPTION

Example embodiments, as described below, may be used to provide a method of securing a networked device.

The present invention is a portable secured storage device connected to a more capable trusted device over a network. Specifically, the trusted device is used to store the encryption keys for the encryption mechanism on the secured storage device.

For most cases this network used will be a commonly used personal area network such as Bluetooth, NFC, or ZigBee. In some cases a networking protocol such as Wi-Fi can also be used to simulate a personal area network.

Patents 20090093215, 20110007900, and 20110305340 by Eisenbach are all titled “Automatic Data Encryption and Access Control Based on Bluetooth Proximity”. Each of these patents describes methods and components for a system that actively encrypts and decrypts a secure device, such as a laptop, based on the proximity of another trusted Bluetooth device. The system describes uses a Bluetooth encryption key exchange to establish trust, and then the trusted device encrypts and decrypts on its own if a trusted device is nearby.

There are several disadvantages to this system. One major disadvantage is that the encryption is based on Bluetooth proximity alone. If both devices are lost together, therefore, they will remain paired. The secure device in this situation will never encrypt, leading to a potential data breach.

Furthermore, in the Eisenbach patent the Bluetooth encryption keys are used for establishing a secure connection. The encryption key used to encrypt the data on the secured data storage device, therefore, must be stored on the secured data storage device so that the encrypted device can encrypt or decrypt itself based on the proximity of the trusted device as described in the patent. Keeping the key on the secured data storage device represents a security risk because if the device can be reverse-engineered the key can be revealed.

Additionally, Bluetooth keys are generally only 128 bits. A 128 bit key is significantly weaker than the 256 bit AES keys commonly used in data storage. If pairing can be spoofed so that the secured data storage device believes the trusted device is nearby when it's not, the secured data storage device will be decrypted because it will believe the trusted device is nearby. Due to the possibility of this spoofing technique, the Eisenbach encryption control method is only as strong as Bluetooth key which is not as secure as many users would desire.

The invention presented here eliminates the Eisenbach system weaknesses by managing a strong encryption key on a network connected trusted device. The key is only transferred to the trusted device when necessary and in a volatile way so that it only exists for small pieces of data for as long as necessary. Once either device loses power or becomes unpaired from the other the key will no longer exist on the trusted device. If both devices are lost together, therefore, the data on the trusted device will not be accessible even if the devices are paired. If both devices are lost together and the trusted device deletes the key through a remote wipe or some other function the trusted device will be impossible to access. This innovation allows integration of mobile device management tools into methods claimed here.

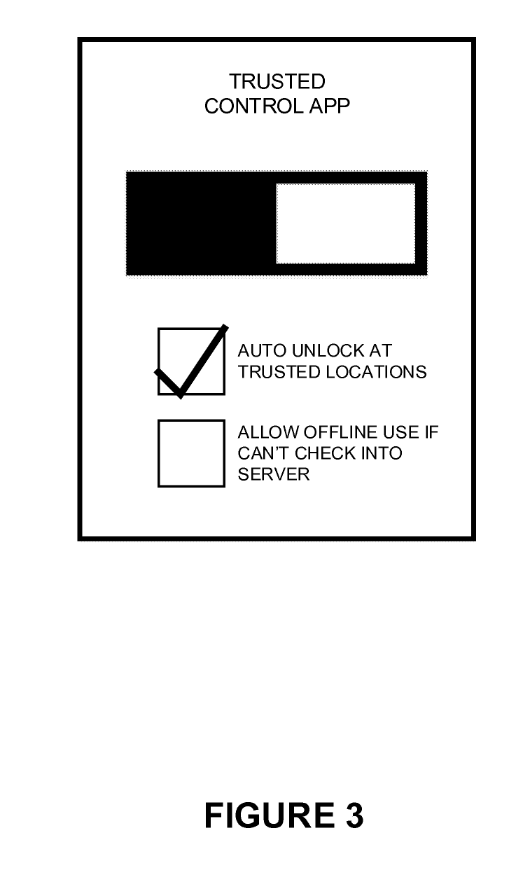

In addition, because the trusted device storing the keys can potentially have more computing power than the storage device, key transfers can be managed through user intervention. For instance, if the trusted device runs a management app the user might have a GUI that allows them to provide permission to allow or deny the key transfer (see FIG. 3). The user can also deny the transfer of a key depending on the state of the device—If the trusted device is a mobile phone or tablet, for instance, the key transfer can be partially based on whether or not the trusted device is locked or unlocked. Key permissions can also be controlled by the use of location contexts detected on the trusted device, such as GPS positions or the availability of and access to local Wi-Fi networks.

The main method of the Eisenbach patent, controlling encryption based on Bluetooth proximity, is not needed with our invention. Keeping the key on the trusted provides passive device detection to control encryption and decryption. If the trusted device can't be paired, the key won't ever be available. This is a much safer and more reliable technique than the proximity monitoring described in Eisenbach.

Any personal area network, such as NFC, Wi-Fi, Zigby or Bluetooth can be used to pair the secured and trusted devices. Unlike with the Eisenbach patent, there's no need with the methods claimed here to securely pair the trusted and secure devices as the pairing itself isn't used to control encryption. The trusted and secure devices can use their own secure protocols to transfer data on top of an insecure pairing. Furthermore, a plurality of trusted devices can exist that maintain copies of the same encryption key for the trusted device. These devices can exist across several networks.

Another embodiment would derive the encryption key on the trusted device from the Bluetooth pairing key used to secure pairing with it to provide a potentially higher level of security. Also, for system design simplicity, the encryption key can be identical to the pairing key. To achieve 256 bit encryption with a shorter Bluetooth key a salt (random data used to modify an existing password or key) can be used to lengthen the key.

Furthermore, the encryption keys used can be symmetric or asymmetric. Unlike with a symmetric key, such as the pairing key used with Bluetooth, an asymmetric key provides public (encryption only) and private (decryption or encryption+decryption) keys. In the case of an asymmetric key the system might only have permission to transfer only a specific type of key. This would provide a method for files on the secure device to be added to but never viewed.

Another embodiment of this invention will be to have an external local or wide area networked service work with the trusted device to establish whether or not an encryption key should be provided to the secured data storage device. This service, for instance, can be some type of cloud server controlled by the company using the secured storage devices. When a data breach occurs on a specific site the company might opt to deny access to flash drives used at that site. To provide even stronger protection the keys can be stored on the service itself and only transferred to the trusted and secured data storage device as needed.

Because many of the trusted devices will have some kind of environmental context (location, sound, pressure, access to certain Wi-Fi networks, etc.) it is also possible to link the permissions of the trusted device to environmental context attributes. For example, geo-fencing might be used to provide access to a USB device only at a certain user's household or if a company Wi-Fi network is present and can be logged into.

Extremely secure embodiments of the device might implement extra security features. For instance, if a request for a key is denied enough times or if a key isn't used within a certain period of time, the trusted device might ask the user or verification server for some type of extra validation before use such as a 2^{nd} password, token key, or an answer to a challenge question. For extra security the secure device can also wipe out all of its data if certain non-secure condition characteristics are met. Furthermore, many mobile devices contain token seeds, such as those used to generate SecureID passcodes. If the trusted device contains a token seeds then the token seed can also be used to allow or deny sending of the encryption key. The token seed can also be used to partially or fully generate the encryption key.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a non-transitory machine-readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes and methods disclosed herein may be embodied in a non-transitory machine-readable medium and/or a machine-accessible medium compatible with a data processing system (e.g., data processing device 100). Accordingly, the specification and drawings are to be regarded in an illustrative rather than a restrictive sense.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

What is claimed is:

1. A system comprising:
a trusted device comprising:
a memory storing an encryption key;
a processor;
a secured data storage device comprising:
a memory, wherein a portion of the memory is allocated for sensitive data;
a processor, configured to pair, through a network, with the trusted device;
wherein the memory of the trusted device comprises instructions that when executed by
the processor of the trusted device cause the trusted device to transfer, through the
first network, the encryption key to the secured data storage device; and
wherein upon receiving the encryption key, the secured data storage device enables
access to the allocated portion of the memory of the secured data storage device.

2. The system of claim 1, wherein the trusted device executes one or more instructions stored in a memory of the trusted device, causing the trusted device to enable management of the encryption key.

3. The system of claim 1, wherein transferring the encryption key is controlled by permissions provided by a user of the trusted device.

4. The system of claim 1, wherein transferring the encryption key is controlled by an external server communicatively coupled to the trusted device through the network or another network.

5. The system of claim 4, wherein the encryption key is stored in the external server and only provided upon request as necessary to improve security.

6. The system of claim 1, wherein the encryption key is a combination of a network pairing key and a password chosen by an end user of the trusted device and the secured data storage device.

7. The system of claim 1, wherein the encryption key is a network pairing key and salt.

8. The system of claim 1, wherein transferring the encryption key is controlled by one or more environmental context attributes on the trusted device, such as the access to specific Wi-Fi networks or the GPS location of the device.

9. The system of claim 1, wherein the transferred encryption key is half of a temporary asymmetric key and wherein the temporary asymmetric key is a public key or a private key.

10. The system of claim 1, wherein a user of the trusted device must provide a password or a code to access the encryption key of the trusted device.

11. The system of claim 1, wherein the encryption key is partially or fully derived from a password or code entered by a user of the trusted device.

12. The system of claim 1, wherein a timer is used to periodically re-request a valid key from the trusted device if one is not provided.

13. The system of claim 1, wherein a loss of the encryption key is ensured using a timeout.

14. The system of claim 1, wherein a loss or a transfer of the encryption key is controlled by at least one context attribute of an environmental context attribute or a location context attribute such as a global positioning system (GPS) geo-fence or access to a specific Wi-Fi network.

15. The system of claim 1, wherein the pairing of the trusted device to the secured data storage device is actively monitored by the secured data storage device and wherein unpairing the trusted device from the secured data storage device deletes the encryption key from the secured data storage device.

16. The system of claim 1, wherein if a request for an encryption key is denied a pre-determined number of times, the trusted device will delete all data stored in the memory of the secured data storage device.

17. The system of claim 1, wherein if a request for an encryption key is denied a pre-determined number of times, the trusted device will require an extra permission in order to provide an encryption key.

18. The system of claim 1, wherein if a request for an encryption key is not requested after a pre-determined period of time, the trusted device will require an extra permission in order to provide an encryption key.

19. The system of claim 1, wherein the encryption key is validated using a seed from another authentication mechanism employed by the trusted device.

20. The system of claim 1, wherein the encryption key used for the secured data storage device is partially or fully generated by a seed from another authentication mechanism employed by the trusted device.
